(19) United States
(12) Patent Application Publication
(10) Pub. No.: US 2010/0125228 A1
(43) Pub. Date: May 20, 2010

(54) Patting Device for Health Care

(76) Inventor: Woody YAO, San Chung City (TW)

Correspondence Address: HDLS Patent & Trademark Services, P.O. BOX 220746, CHANTILLY, VA, 20153-0746, US

(21) Appl. No.: 12/271,026

(22) Filed: Nov. 14, 2008

(51) Int. Cl. A61H 23/00

(52) U.S. Cl. 601/111; 601/107; 601/108

(57) ABSTRACT

A patting device includes a case for containing other structures; a motor disposed in the case for rotation; a power source installed in the case to provide power to the motor; a transmission structure connected to an output shaft of the motor to transmit power of the motor; and a patting structure at least comprising a turntable connected to and driven by the transmission structure, wherein the turntable includes a protruding block disposed off-axis with respect to the turntable, and a ring body is disposed around the protruding block and connected with a patting bar extending out of the case. Hence, the power of the motor is transmitted through the transmission structure to the patting structure; when the turntable rotates, the off-axis placement of the protruding block drives the patting bar to move back and forth to let the patting bar pat the human body to provide health care effects.

### BACKGROUND OF THE INVENTION

1. Field of the Invention

The present invention relates to a patting device, and more particularly, to a health care device which is driven by a gear to let a patting bar on a patting device move retractably along an axis to pat the human body.

2. Description of the Prior Art

The advance of civilization has improved the living standard; furthermore, better health care has prolonged average life span of people as well.

However, due to changed life styles, modern day people are more likely to encounter immunity problems and suffer from various kinds of disease caused by lack of exercise, unbalanced diet and irregular sleep pattern.

Therefore, it is critical for people to find ways to improve personal health and to avoid sickness.

In traditional Chinese health care practices, it is a known fact that patting the human body can improve health; however, the type of equipment and its availability are the concerns in using patting equipment.

Taiwan Patent numbered M325223 discloses an implementation using vibration generated by a centrifugal block disposed on the motor when the motor rotates; however, this implementation only provides vibration effects and no patting effects.

Taiwan Patent numbered M320388 also discloses an implementation using a centrifugal block to provide vibration effects and also a turntable comprising a protruding block for rotation to let the protruding block in contact with the human body, however, this implementation does not provide patting effects either.

Furthermore, Taiwan Patent numbered 86209977 discloses an implementation using a gear to drive a plurality of transmission bar to generate circular movement on a plane; still, this implementation does not provide patting effects either.

Therefore, the traditional health care equipments do not provide patting effects to realize practical and effective health care practices and need improvement.

In view of the above-described deficiencies of the traditional health care equipment, after years of constant efforts in research, the inventor of this invention has consequently developed and proposed a patting device in the present invention.

### SUMMARY OF THE INVENTION

It is an object of the present invention to provide a patting device which can pat the human body to provide health care effects.

It is another object of the present invention to provide a patting device which is simple in structure, easy to dispose, and easy to operate for people, thereby helping promote the patting device.

It is still another object of the present invention to provide a patting device which provides various implementations to let the user choose a suitable patting type for him/her.

The present invention discloses a patting device, which comprises a case for containing other structures; a motor disposed in the case for rotation; a power source installed in the case to provide power to the motor; a transmission structure connected to an output shaft of the motor to transmit power of the motor; and a patting structure at least comprising a turntable connected to and driven by the transmission structure, wherein the turntable comprises a protruding block disposed off-axis with respect to the turntable, a ring body is disposed around the protruding block and connected with a patting bar extending out of the case. Hence, the power of the motor is transmitted through the transmission structure to the patting structure. When the turntable rotates, the off-axis placement of the protruding block drives the patting bar to move back and forth to let the patting bar pat the human body to provide health care effects.

### BRIEF DESCRIPTION OF THE DRAWINGS

Please refer to the following description and figures for further understanding of the present invention and its objects, wherein:

FIG. 1 illustrates a perspective view of the patting device in a first embodiment of the present invention;

FIG. 2 illustrates another perspective view of the patting device in the first embodiment of the present invention from another angle;

FIG. 3 illustrates a vertical view of the patting device in the first embodiment of the present invention;

FIG. 4 illustrates a front view of the patting device in the first embodiment of the present invention;

FIG. 5 illustrates a perspective view of the patting device in a second embodiment of the present invention;

FIG. 6 illustrates another perspective view of the patting device in the second embodiment of the present invention from another angle;

FIG. 7 illustrates a vertical view of the patting device in the second embodiment of the present invention;

FIG. 8 illustrates a front view of the patting device in the second embodiment of the present invention;

FIG. 9 illustrates a perspective view of the patting device in a third embodiment of the present invention;

FIG. 10 illustrates a vertical view of the patting device in the third embodiment of the present invention;

FIG. 11 illustrates a front view of the patting device in the third embodiment of the present invention;

FIG. 12 illustrates a perspective view of the patting device in a fourth embodiment of the present invention;

FIG. 13 illustrates a vertical view of the patting device in the fourth embodiment of the present invention;

FIG. 14 illustrates a front view of the patting device in the fourth embodiment of the present invention;

FIG. 15 illustrates a perspective view of the patting device in a fifth embodiment of the present invention;

FIG. 16 illustrates a vertical view of the patting device in the fifth embodiment of the present invention;

FIG. 17 illustrates a front view of the patting device in the fifth embodiment of the present invention;

FIG. 18 illustrates a perspective view of the patting device in a sixth embodiment of the present invention;

FIG. 19 illustrates a vertical view of the patting device in the sixth embodiment of the present invention;

FIG. 20 illustrates a front view of the patting device in the sixth embodiment of the present invention;

FIG. 21 illustrates a perspective view of the patting device in a seventh embodiment of the present invention;

FIG. 22 illustrates a vertical view of the patting device in the seventh embodiment of the present invention;

FIG. 23 illustrates a front view of the patting device in the seventh embodiment of the present invention;

### DETAILED DESCRIPTION OF THE PREFERRED EMBODIMENT

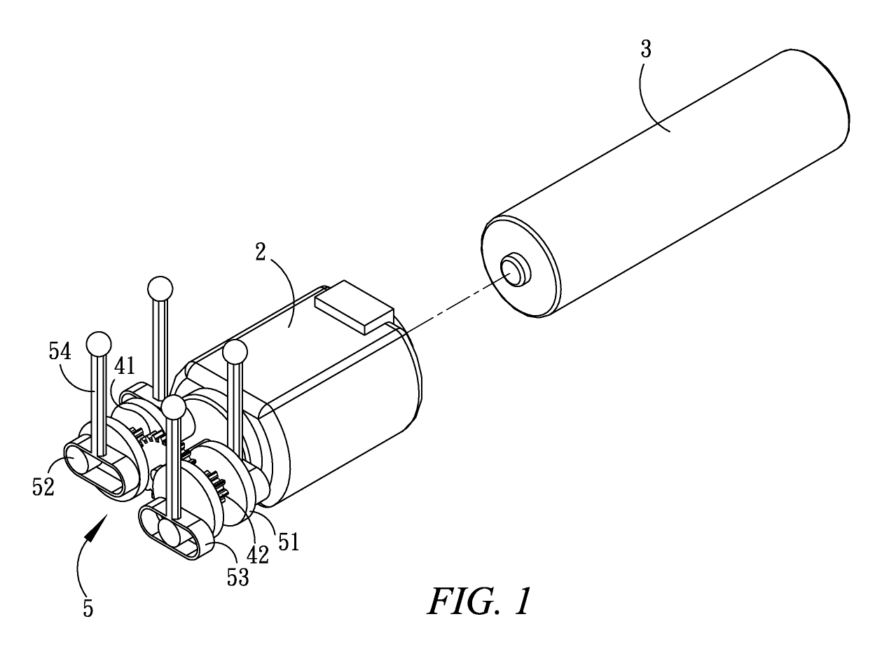

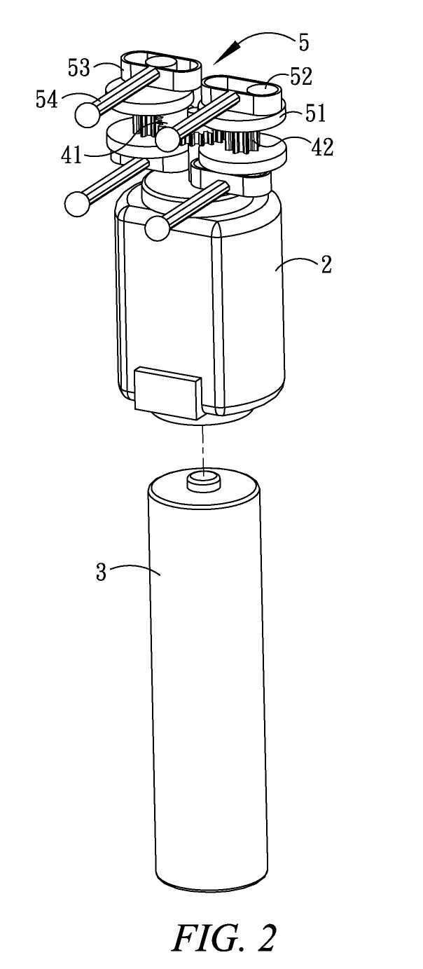

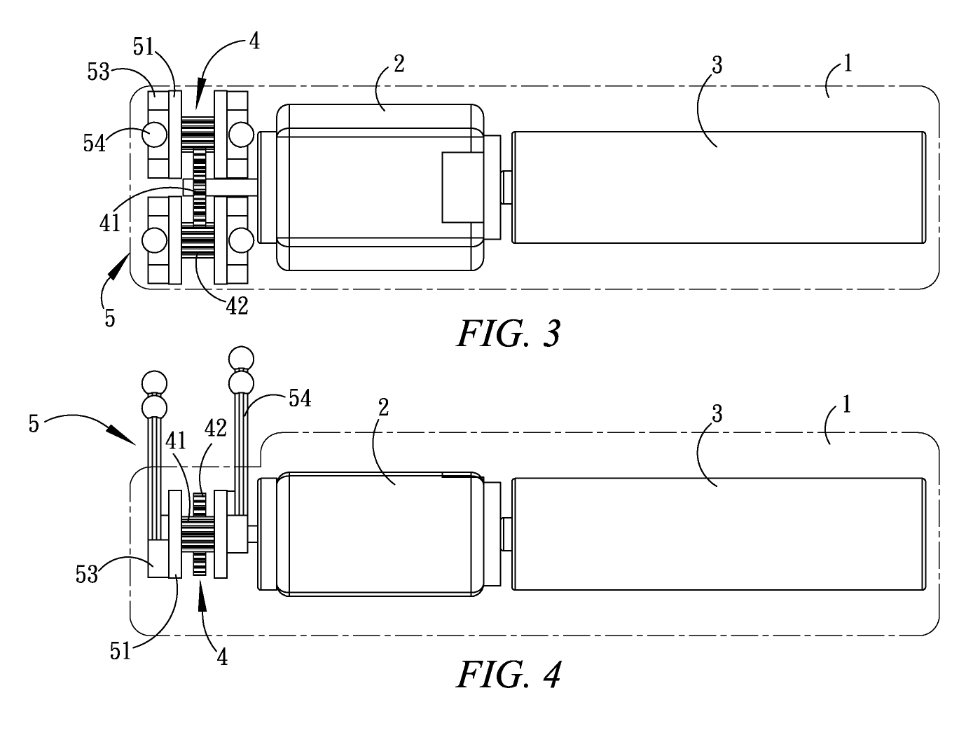

Please refer to FIG. 1 to FIG. 4 for a patting device in a first embodiment of the present invention. The patting device mainly comprises a case 1, a motor 2, a power source 3, a transmission structure 4 and a patting structure 5. The case 1 is used for containing other structures and is not limited to any specific kind of shape. The motor 2 is installed in the case 1 to generate power to drive the transmission structure 4 and the patting structure 5 and is powered by the power source 3, which is a battery in this embodiment. In practical use, the power source 3 can be implemented with an AC/DC converter to couple with the utility power. The case 1, the motor 2, and the power source 3 are known in the art and will not be further described.

The main feature of the present invention lies in the transmission structure 4, the patting structure 5 and their arrangements. The transmission structure 4 is connected to an output shaft of the motor 2 and driven by the motor 2 to transmit power of the motor 2. The patting structure 5 at least comprising a turntable 51 connected to and driven by the transmission structure 4, wherein the turntable 51 comprises a protruding block 52 disposed off-axis with respect to the turntable 51, and a ring body 53 is disposed around the protruding block 52 and connected with a patting bar 54 extending out of the case 1.

Hence, when the patting device is activated, the power of the motor 2 is transmitted through the transmission structure 4 to the patting structure 5. When the turntable 51 rotates, the off-axis placement of the protruding block 52 drives the patting bar 54 to move back and forth to let the patting bar 54 pat the human body to provide health care effects.

Furthermore, the transmission structure 4 comprises a driving gear 41 and a driven gear 42, the driving gear 41 is driven by an output shaft of the motor 2, the driven gear 42 is engaged with the driving gear 41 to rotate with the driving gear, and the turntable 51 of the patting structure 5 is disposed on a same axis with the driven gear 42 to let the driven gear 42 drive the turntable 51 to rotate synchronously. By changing the gear ratio between the driving gear 41 and the driven gear 42, it is possible to adjust a patting frequency (rhythm) of the patting bar 54.

The patting device 5 is disposed with a plurality of patting bar 54, in this embodiment, the number of the patting bar 54 is four; each patting bar 54 has a separate turntable 51 and protruding block 52. For space saving concern, it is possible to use one driving gear 41 to drive two driven gears 42, and each driven gear 42 is disposed with a patting bars 54 and related components at each side and on the same axle thereof. Hence, when the motor 2 is activated, it is possible to use four patting bar 54 to achieve patting effects. Each patting bar comprises a protruding block 52 disposed off-axis with a different angle with respect to the turntable 51 to let each patting bar 54 protrude out of the case 1 with a different length at the same time to generate a continuous patting rhythm.

Besides, the ring body 53 of the patting bar is extended by a length perpendicular to the protruding direction of the patting bar 54 to let the protruding block 52 move in the ring body 53. When the turntable 51 is rotating, the protruding block 52 pushes the ring body 53 to move the patting bar 54. Since the movement of the patting bar 54 is limited inside the extended length of the ring body 53, the patting bar can move back and forth on a single direction on the axis and apply its full force on the human body with no side force loss.

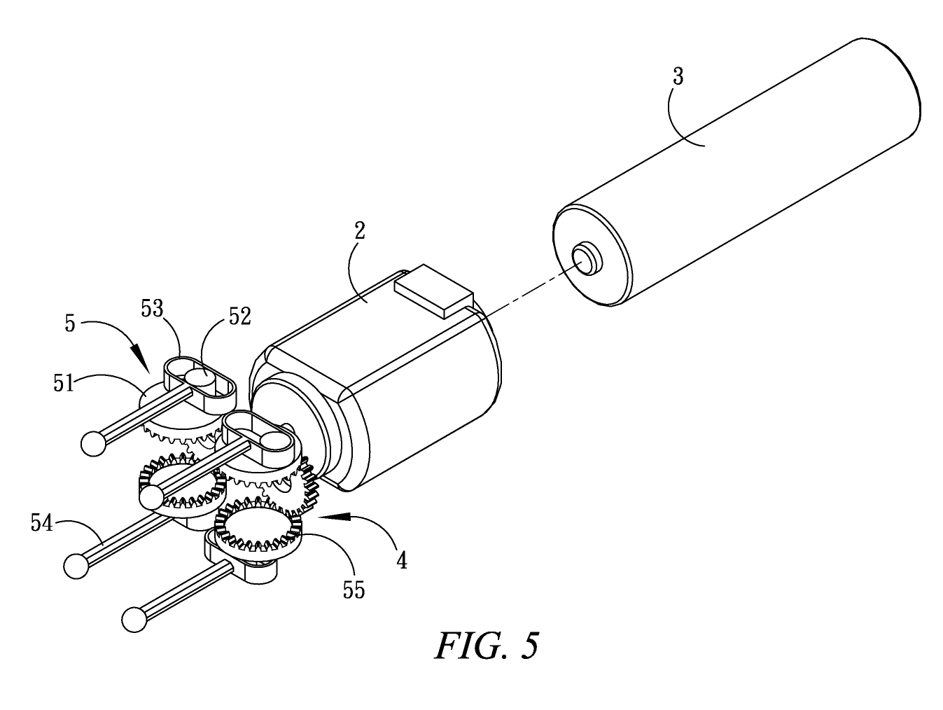

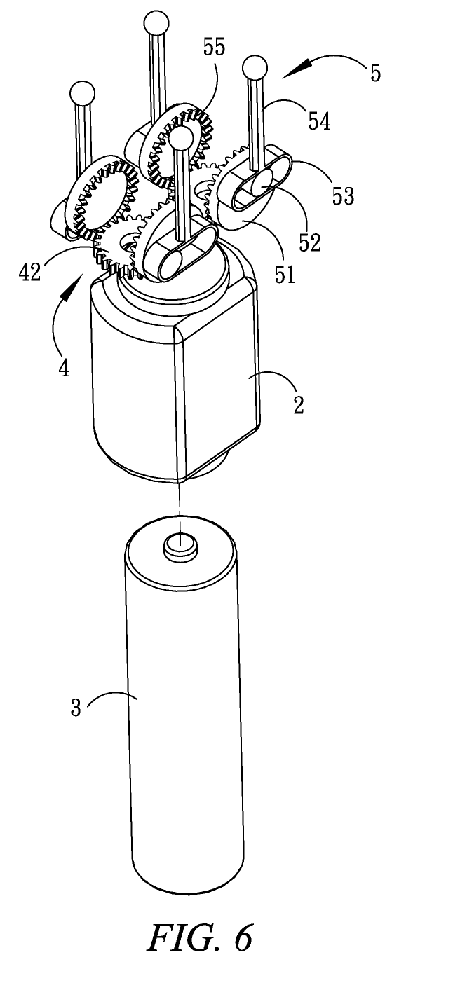

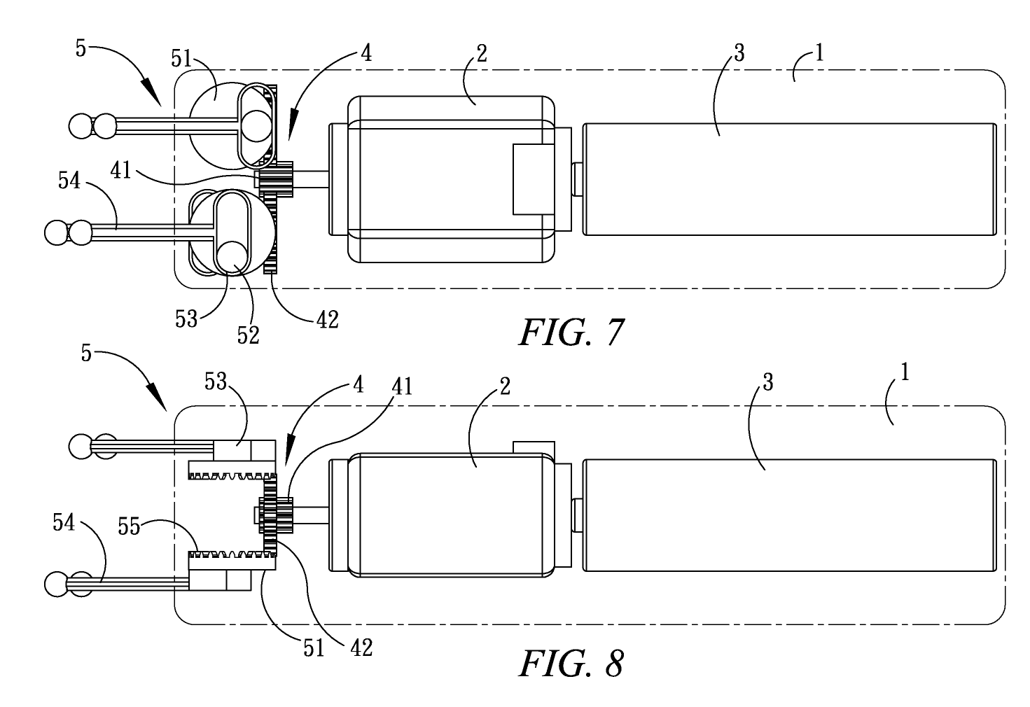

Please refer to FIG. 5 to FIG. 8 for the patting device in a second embodiment of the present invention. The second embodiment is different from the first embodiment in that the turntable 51 of the patting structure 5 is integrated on a crown gear 55, and the so-called crown gear 55 has its gear teeth disposed on a plane at the outer rim of its perimeter. The crown gear 55 is characterized in that its rotation plane is perpendicular to that of the driven gear 42. Therefore, the crown gear 55 engages with the driven gear 42 to rotate the driven gear 42, and the crown gear 55 can be used for changing the rotation direction of the turntable 51 to let the patting bar 54 move back and forth on a direction parallel to the axial direction of the driving gear 51. Similarly, four patting bars 54 are implemented in this embodiment, each driven gear 42 is disposed with two patting bars 54, and each patting bar 54 comprising a protruding block 52 disposed off-axis with a different angle with respect to the axis of the turntable 51 to let each patting bar 54 protrude out of the case 1 with a different length at the same time to generate a continuous patting rhythm.

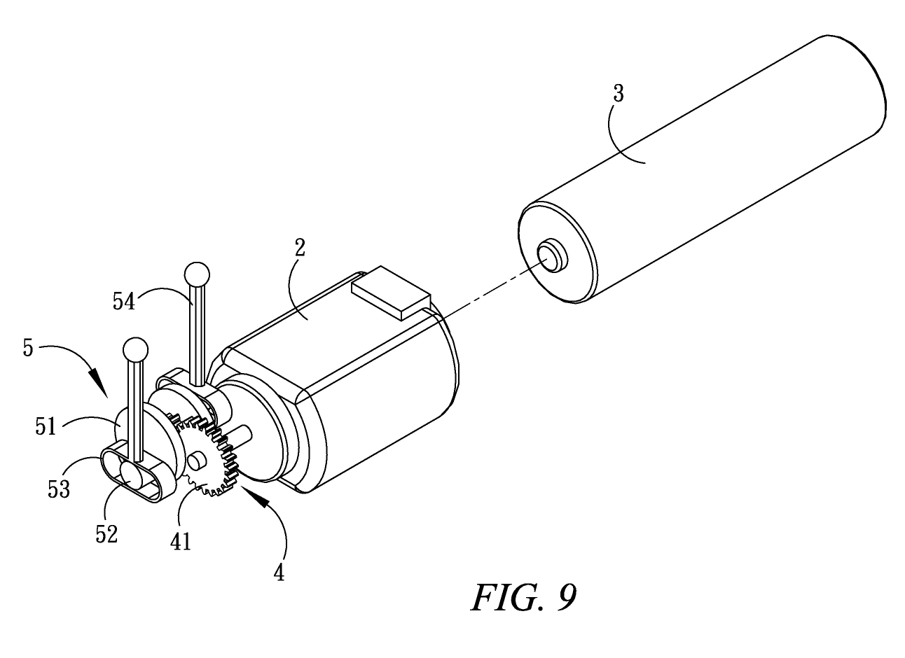

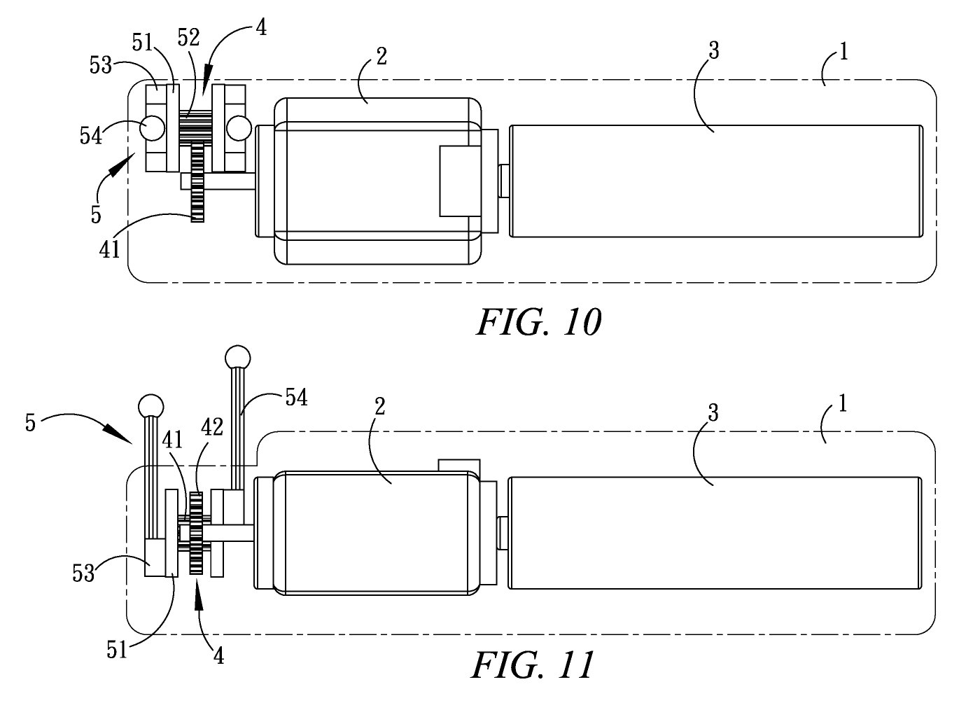

Please refer to FIG. 9 to FIG. 11 for the patting device in a third embodiment of the present invention. The third embodiment is a variation of the first embodiment, wherein the driving gear 41 only drives one driven gear 42, the patting bars 54 on each side of the driven gear 42 and related components on one side. Each patting bar 54 comprises a protruding block 52 disposed off-axis with a different angle with respect to the axis of the turntable 51 to generate a continuous patting rhythm.

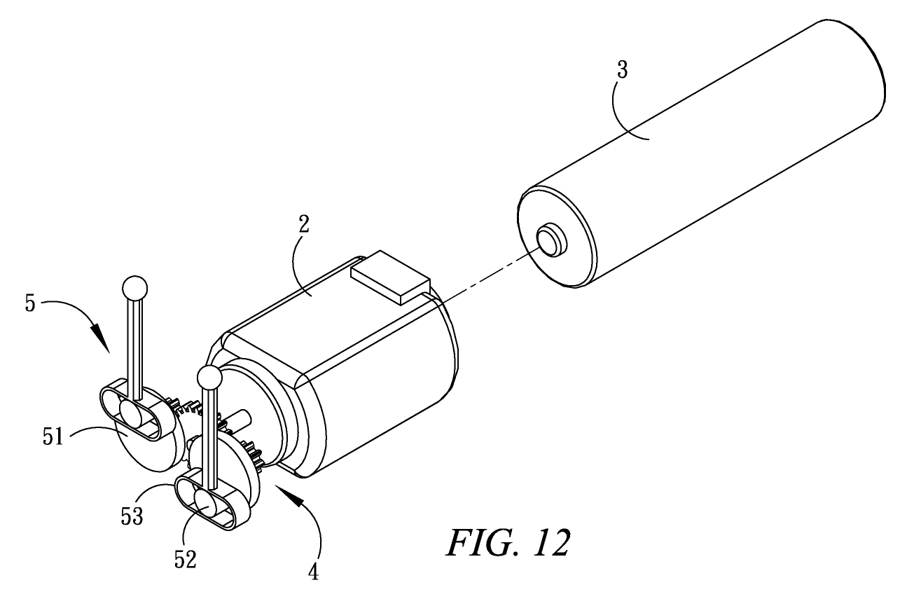

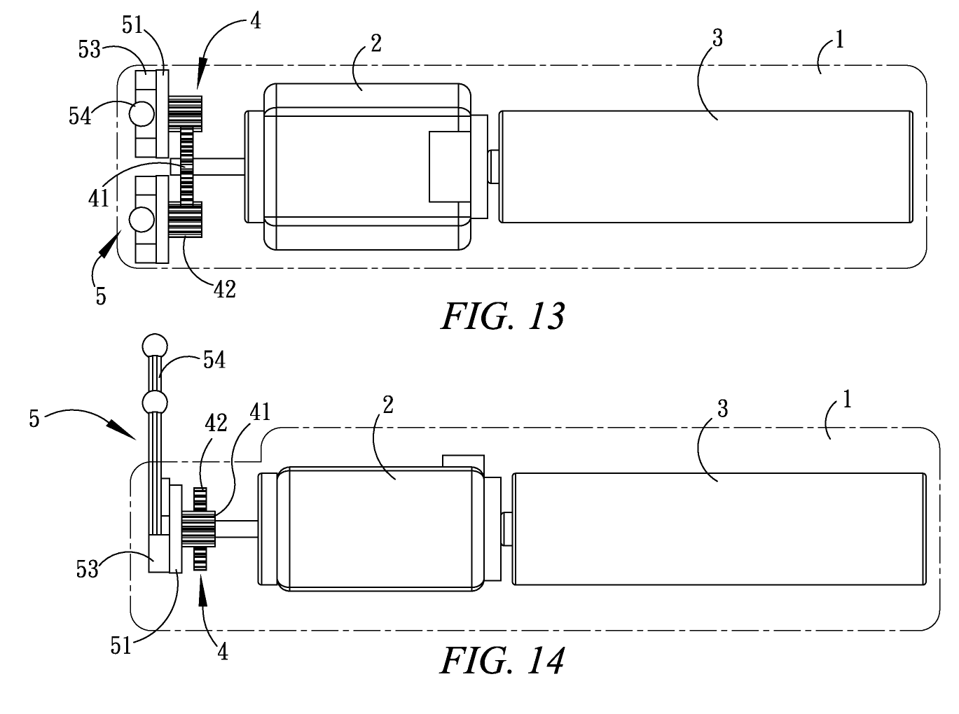

Please refer to FIG. 12 to FIG. 14 for the patting device in a fourth embodiment of the present invention. The fourth embodiment is a variation of the first embodiment, wherein each of the two driven gears 42 drives only one patting bar 54 and related components. Similarly, each patting bar 54 comprises a protruding block 52 disposed off-axis with a different angle with respect to the axis of the turntable 51 to generate a continuous patting rhythm.

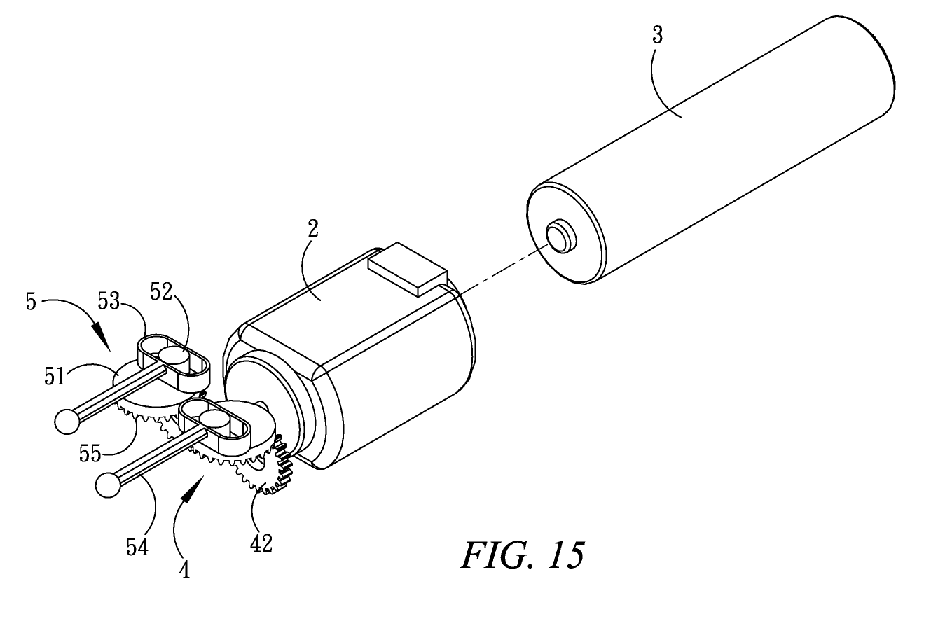

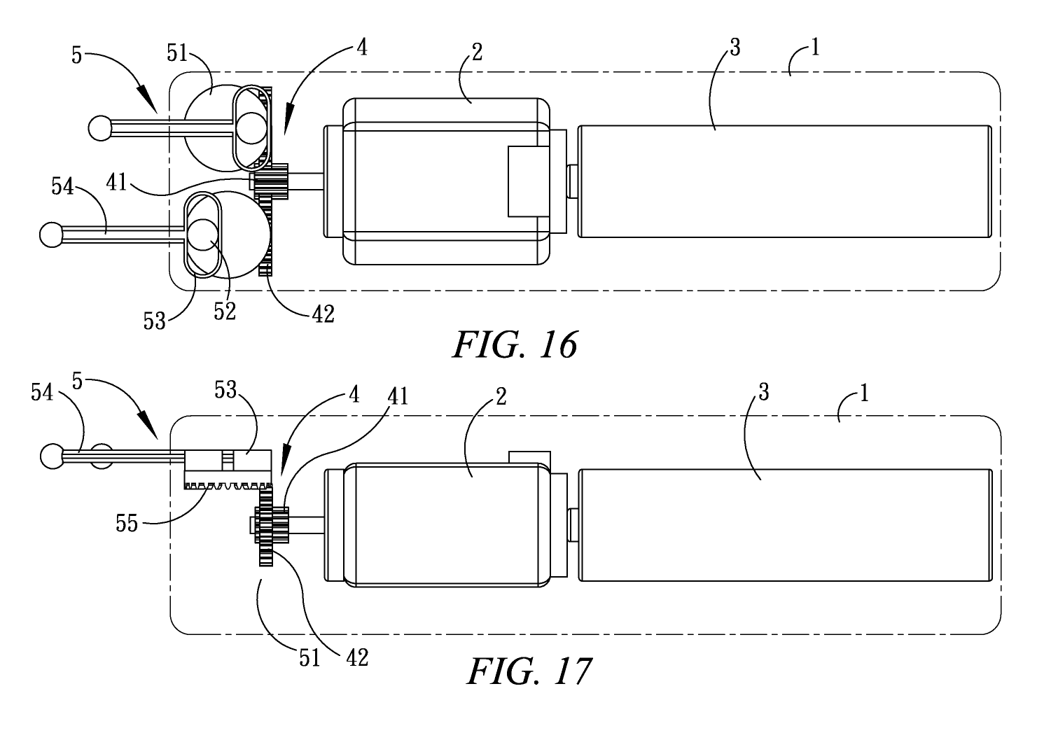

Please refer to FIG. 15 to FIG. 17 for the patting device in a fifth embodiment of the present invention. The fifth embodiment is a variation of the second embodiment, wherein the two driven gears 42 drives only one patting bar 54 and related components.

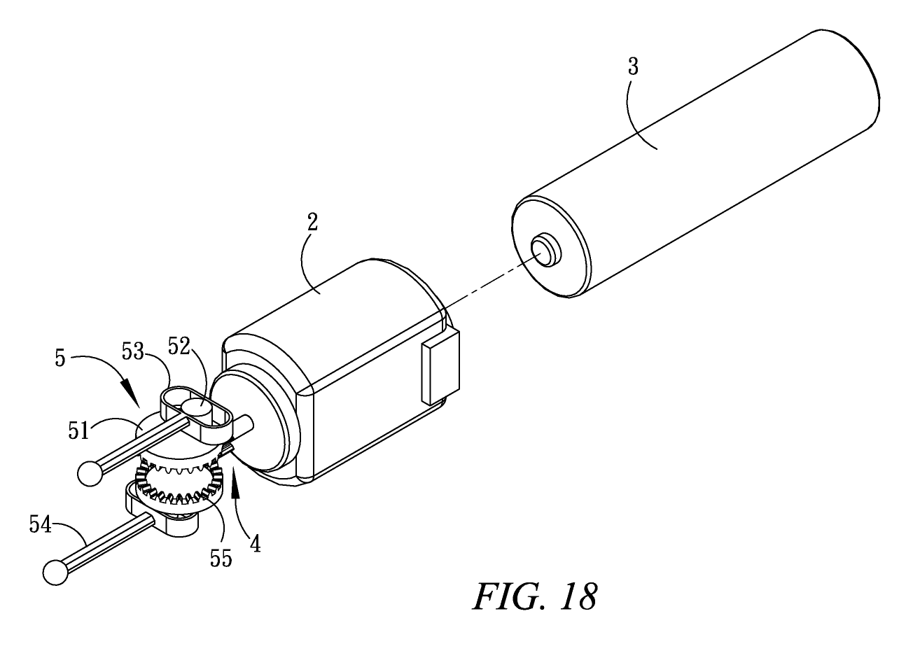

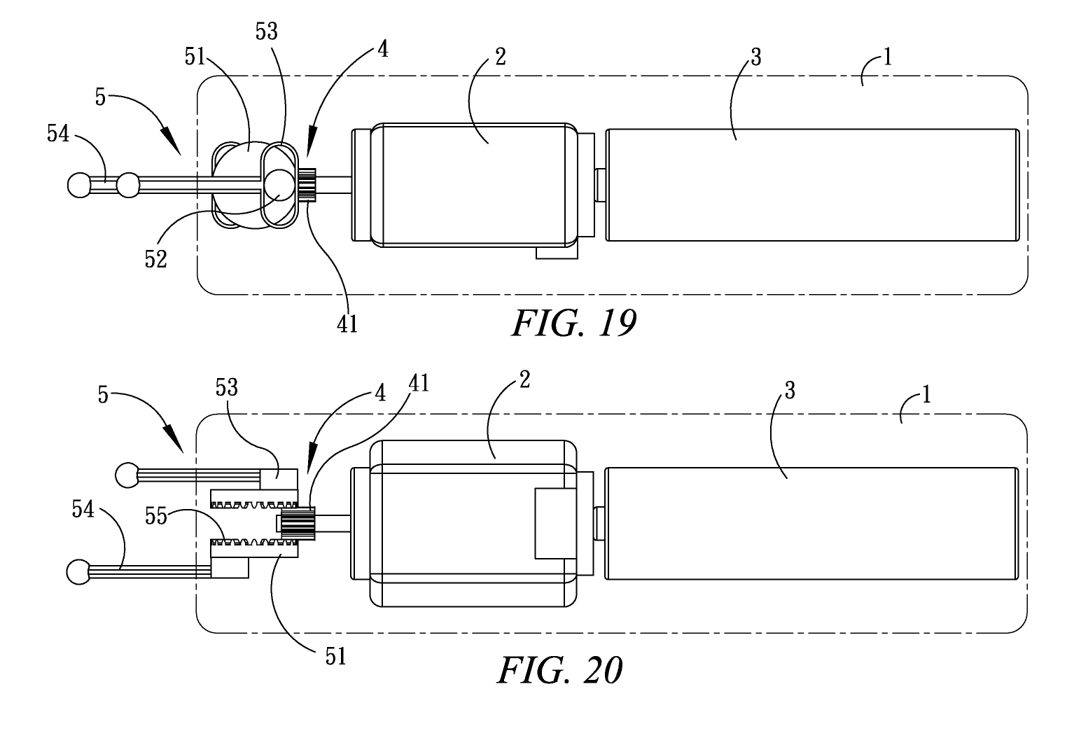

Please refer to FIG. 18 to FIG. 20 for the patting device in a sixth embodiment of the present invention. The sixth embodiment is a variation of the second embodiment, wherein the crown gears 55 of the two patting bars 54 are directly engaged with the driving gear 41, while no driven gears 42 are used, it is possible to simplify space arrangement, to reduce power loss and to improve output power efficiency.

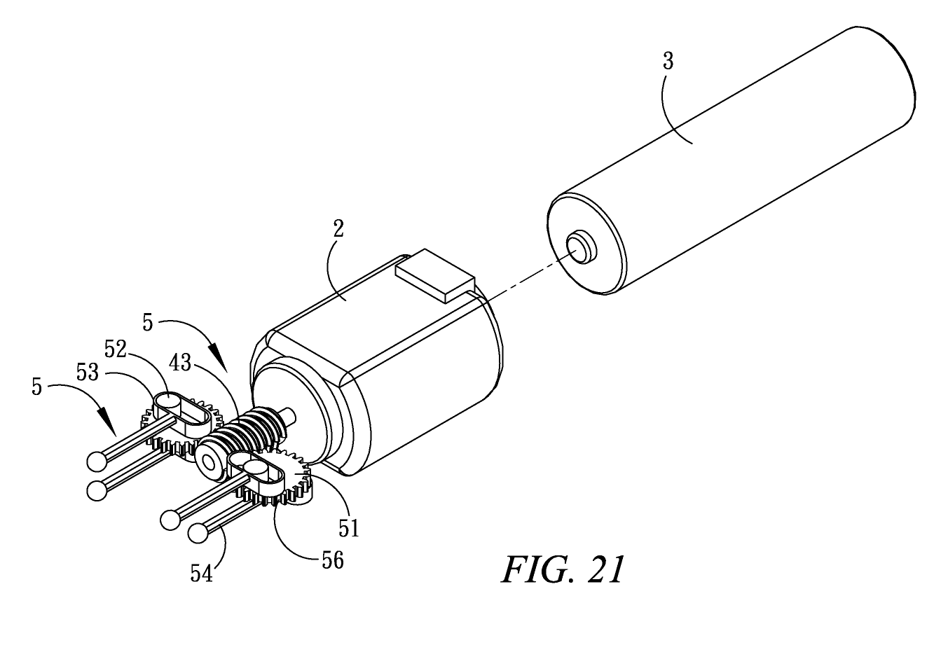

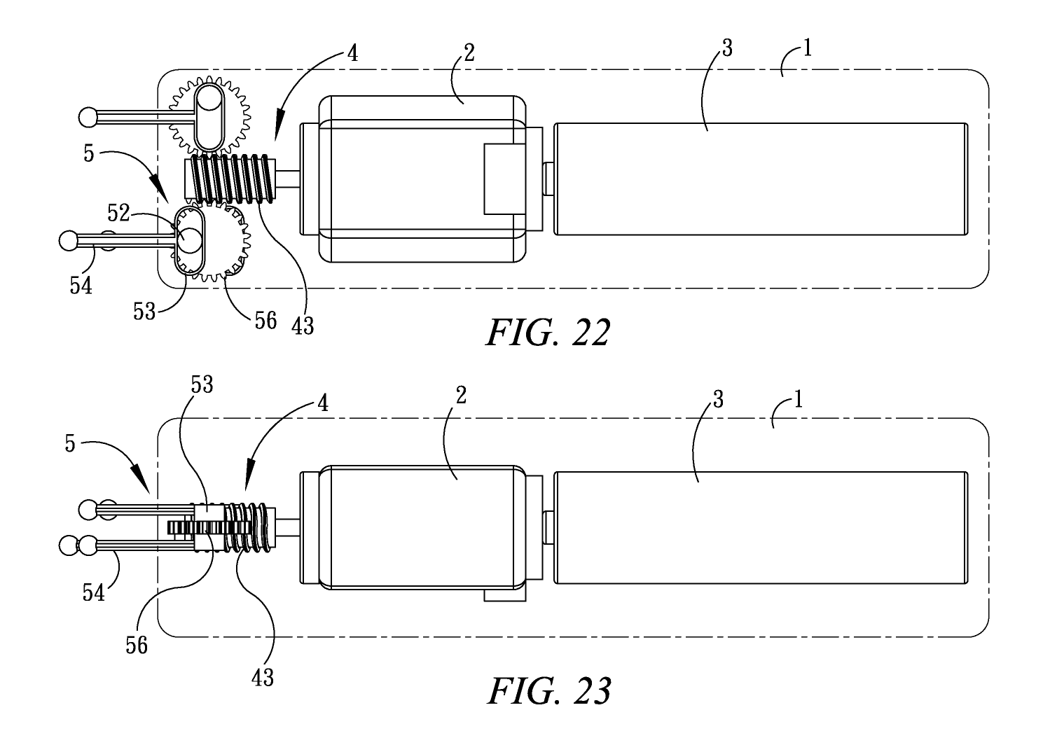

Please refer to FIG. 21 to FIG. 23 for the patting device in a sixth embodiment of the present invention. The transmission structure 4 comprises a turbine 43 which is rotated and driven by the output shaft of the motor 2; the turntable 51 of the patting structure 5 is integrated with a gear 56, which is engaged with the turbine 43. The structure of the turbine 43 can change the rotation direction and provide irreversible transmission, therefore it is possible to change the rotation direction of the turntable 51 and to provide a more stable power output.

The present invention provides a patting device, while comparing with other prior art techniques, is advantageous in:

1. The present invention provides a patting device which can pat the human body to provide health care effects.

2. The present invention provides a patting device which is simple in structure and portable for the user to use it at designated positions at any time to improve personal health.

3. The present invention provides a patting device which provides various implementations to let the user choose a suitable patting type for him/her.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A patting device comprising:
a case;
a motor disposed in the case;
a power source installed in the case to provide power to the motor;
a transmission structure connected to an output shaft of the motor to transmit power of the motor; and
a patting structure at least comprising a turntable connected to and driven by the transmission structure, wherein the turntable comprises a protruding block disposed off-axis with respect to the turntable, a ring body is disposed around the protruding block and connected with a patting bar extending out of the case.

2. The patting device as claimed in claim 1, wherein the transmission structure comprises a driving gear and a driven gear; the driving gear is driven by the output shaft of the motor, and the driven gear is engaged with the driving gear to rotate with the driving gear so as to drive the patting structure.

3. The patting device as claimed in claim 2, wherein the turntable of the patting structure is disposed on a same axis with the driven gear to let the driven gear drive the turntable to rotate.

4. The patting device as claimed in claim 2, wherein the turntable of the patting structure is integrated with a crown gear which is engaged with the driven gear to rotate with the driven gear and to change a rotation direction of the turntable.

5. The patting device as claimed in claim 1, wherein the transmission structure comprises a driving gear driven and rotated by the output shaft of the motor, and the turntable of the patting structure is integrated with a crown gear which is engaged with the driving gear to rotate with the driving gear and to change a rotation direction of the turntable.

6. The patting device as claimed in claim 1, wherein the transmission structure comprises a turbine driven and rotated by the output shaft of the motor, and the turntable of the patting structure is integrated with a gear which is engaged with the turbine to change a rotation direction of the turntable.

7. The patting device as claimed in claim 1, wherein the patting device is disposed with a plurality of patting bars, each patting bar comprising a protruding block disposed off-axis with a different angle with respect to the turntable to let each patting bar protrude out of the case with a different length at the same time to generate a continuous patting effect.

8. The patting device as claimed in claim 1, wherein the ring body of the patting bar is extended by a length perpendicular to the protruding direction of the patting bar to let the protruding block move in the ring body when the turntable is rotating and to keep the patting bar moving back and forth on a single direction.
